(19) United States
(12) Patent Application Publication
(10) Pub. No.: US 2005/0140658 A1
(43) Pub. Date: Jun. 30, 2005

(54) Multidirectional key keypad for entering alphanumeric data

(76) Inventor: Tzechung Kao, Irvine, CA (US)

Correspondence Address: DAVID AND RAYMOND PATENT GROUP, 1050 OAKDALE LANE, ARCADIA, CA, 91006, US

(21) Appl. No.: 11/011,326

(22) Filed: Dec. 13, 2004

Related U.S. Application Data
(60) Provisional application No. 60/529,440, filed on Dec. 12, 2003.

(51) Int. Cl. G09G 5/00

(52) U.S. Cl. 345/169

(57) ABSTRACT

The present invention discloses a keypad for entering alphanumerical data, the keypad comprises at least ten multidirectional keys respectively representing basic digits of decimal numerals, wherein each multidirectional key has at least two orientations of freedom permitting said multidirectional key to be selectively depressed along at least two different directions, one of the directions represents one of the basic digits of decimal numerals and other directions represent various characters, such that the keypad is capable of reducing number of said multidirectional keys in order to enter any digit of alphanumerical data with one action of depressing said multidirectional key to a predetermined direction.

### CROSS REFERENCE OF RELATED APPLICATION

This is a Regular Application of a provisional application: 60/529,440, filed Dec. 12, 2003.

### BACKGROUND OF THE PRESENT INVENTION

1. Field of Invention

The present invention relates to a multidirectional key keypad, and more particularly to a keypad of telephone wherein each key is able to initiate more than one command for entering alphanumerical data.

2. Description of Related Art

A conventional telephone keypad includes twelve keys representing numerals from “0” through “9” plus two functional keys, the star key and pump key. Labels of the numerals, star symbol and pump symbol are imprinted on the keys for purpose of indication. A telephone number is a combination of a series of the numerals, sometimes even including the functional keys for a networked telephone system. Find prints of characters are provided on the keys by the imprinted numerals and functional symbols. For example, a key imprinted with numeral “2” has characters “A,” “B,” and “C” as finer prints by the side. One Function of having those characters is to help a user to memorize a telephone number in a mnemonic way. For example, the telephone number “786-239” can be memorized as “SUNDAY” as referring to the characters represented by the numerals of the telephone number. The mnemonic numbers have been widely used for commercial purposes in order to impress the consumers with the merchant's contact information.

As the technology developed, a telephone has incorporated functions way more than just making a phone call. A cellular phone usually includes various functions, such as phone books, digital organizers and games. Those extra functions require the cellular phone to have a capability of entering the names, addresses, and some complete writings. It is impractical for a cellular phone to adopt a keypad having tens of keys, each representing a numeral, symbol or English letter. Such a keypad would be too big in size to be commercial feasible. Therefore, the conventional twelve-key keypad provides a solution.

One way of using the conventional twelve-key keypad to enter English letters is by exploitation of fine characters imprinted on each key. A cellular phone is programmed to understand the user's intention of which character she is entering by how many times she depresses a key. For example, the user depress the key, which represents numeral “2” and has fine characters “A,” “B,” and “C” imprinted along side, once is understood by the phone that she intends to enter the numeral “2.” If the user depresses the key twice, the phone would interpret as she intends to enter the character “A.” Likewise, depressing the key three times means the user wants to enter the character “C,” and depressing the key four times means the user wants to enter the character “D.” If the user depresses the key more than four times, the cycle of depressing will be reset and recounted from once again.

The above-mentioned solution has a drawback of complicating and time-consuming. A key of the conventional keypad has four or five choices of entry. As an average, the user needs to depress a key twice to have her desired character found. When the data to be entered is long and containing many words, the number of depressing motions will be roughly the length of the data multiplied by two. Mistakes would happen easily in the course of entering the data for the user loses track of how many times she has depressed a key for a certain character, or the phone misreads one depress as two depresses. Therefore, many actions of correction are required to complete a simple entry of contact information. In the time when cellular phone is getting more like a personal digital assistant, it is a pain to use the telephone keypad to enter lengthy data according to the conventional solution.

Another solution of entering data via the traditional telephone keypad is the so called “T-9” method, which allows the user to depress a key only once and the phone will automatically choose a character from the ones represented by the key. When the user types along, the phone is programmed to choose the characters accordingly to the most possible combination of the meaningful ones. For example, the user depresses keys 3, 2 and 8 in an order. The key 3 may denote “D,” “E,” or “F,” the key 3 may denote “A,” “B,” or “C,” and the key 8 may denote “T,” “U,” or “V.” There are twenty-seven possible combinations for the number “2-3-8.” The possible combinations include “DAU,” “EBV,” and many other ones, among which only few have meanings in English. The phone would choose the combination from the most frequently used words as the user's entry. In this example, the phone would choose “EAT” as the user's entry for it is a meaningful word that is more frequently used among the possible ones.

The “T-9” method eliminates the number of depressing the user is required to make in the course of entering alphanumeric data. However, errors often happen for it is unavoidable that the phone would “guess” wrong in circumstances. They happen particularly a lot when the data the user wants to enter have no particular meaning, such as people's names, company's names and street names. When an error happens, the user is required to move the cursor back to correct the wrong letters.

As such, what is needed is a keypad of telephone that is capable of entering alphanumerical data without lengthy actions of choosing the characters and correcting the errors, such that the user may input her desired alphanumerical data in a simple and time-saving way.

### SUMMARY OF THE PRESENT INVENTION

An objective of the present invention is to provide a keypad for a phone, wherein the keypad has multidirectional keys, each of which can be depressed to various directions in order to respectively make various commands to the phone.

Another objective of the present invention is to provide a multidirectional key keypad for a phone, wherein each multidirectional key can be depressed to various directions that represent various numerals, characters or symbols, such that the keypad is adapted for entering alphanumerical data without depressing the multidirectional key more than once for a single digit of the alphanumerical data.

Another objective of the present invention is to provide a multidirectional key keypad for a phone, wherein the multidirectional key are made in a certain shape suitable for indicating various directions for entering various commands by a single key.

Another objective of the present invention is to provide a multidirectional key keypad, wherein the numerals, characters and symbols are raisedly imprinted on the keys for guiding a user to depress the key to a predetermined direction for a certain numeral, character or symbol with her touching of the key.

Another objective of the present invention is to provide a multidirectional key keypad, wherein a plurality conducting pads for a key are embedded on a printed circuit board in order to generate various command signals representing various numerals, characters and symbols in coordination with the directions that the key is depressed toward.

Another objective of the present invention is to provide a multidirectional key keypad, wherein a set of conductor tracks, whose resistance are adjusted in response to pressure, for a key are embedded on a printed circuit board in order to generate various command signals representing various numerals, characters and symbols in coordination with the directions that the key is depressed toward.

Another objective of the present invention is to provide a method supported by the multidirectional key keypad that permits a user to enter alphanumerical data with one action of depressing the multidirectional key to a certain direction.

The present invention discloses a keypad for entering alphanumerical data comprising:
at least ten multidirectional keys respectively representing basic digits of decimal numerals, wherein each multidirectional key has at least two orientations of freedom permitting the multidirectional key to be selectively depressed along at least two different directions, wherein one of the directions represents one of the basic digits of decimal numerals and the other of the directions represent various characters accordingly, such that the keypad is able to reduce a required number of the multidirectional keys in order for entering any digit of alphanumerical data with one action of depressing the multidirectional key to a certain direction.

The present invention further comprising a method of entering a digit of alphanumerical data with one action of depressing via a keypad for phones, wherein the method comprises the following steps:
(a) providing at least ten multidirectional keys respectively representing basic digits of decimal numerals, wherein each multidirectional key has at least two orientations of freedom permitting the multidirectional key to be selectively depressed along at least two different directions, wherein one of the directions represents one of the basic digits of decimal numerals and the other of the directions represent various characters accordingly; and
(b) depressing the multidirectional key to a certain direction to electrically manipulate a circuitry in such a way that the circuit effects a signal representing a certain numeral, character or symbol,
whereby the multidirectional key is capable of inputting at least two commands, such that the keypad is able to reduce a required number of the multidirectional keys in order for entering any digit of alphanumerical data with one action of depressing the multidirectional key to a certain direction.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of cellular phone having a multidirectional key keypad according to a preferred embodiment of the present invention.

FIG. 2 is a schematic view of the multidirectional key keypad according to the preferred embodiment of the present invention.

FIG. 3 is a schematic view of one multidirectional key and its corresponding electrical components of the multidirectional key keypad, according to the preferred embodiment of the present invention.

FIG. 4 is a cross-sectional view of one multidirectional key and its corresponding electrical components of the multidirectional key keypad, according to the preferred embodiment of the present invention.

FIG. 5 is a top view of the conductor tracks corresponding to the multidirectional key, according to the preferred embodiment of the present invention.

### DETAILED DESCRIPTION OF THE PREFERRED EMBODIMENT

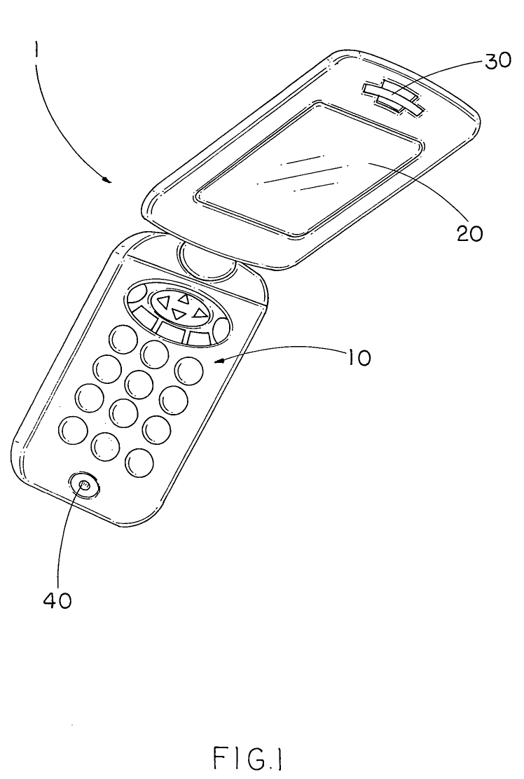

Referring to FIG. 1, a perspective view of a cellular phone 1 incorporated with the disclosed multidirectional key keypad 10 is illustrated according to a preferred embodiment of the present invention. The cellular phone 1 comprises a screen 20 for displaying information, a miniature speaker 30, a microphone 40, and a keypad 10 for entering alphanumerical data. The cellular phone 1 is programmed to have functions more than making a phone call, like phone books, message management, web browsing, digital organizer and games, so that alphanumerical data may be entered for them.

The keypad 10 has a first group of keys including ten basic digits for decimal numerals and two keys for star symbol and pump symbol, and a second group of keys including a key for cursor control and functional keys, such as MENU, CLEAR, SEND, END and SELECT. The MENU key is for pulling out the menu and the cursor control key directs the cursor for selecting of certain functions from the menu. The first group of keys are used for dialing telephone numbers and entering alphanumerical data for the certain functions. For example, the user may depress the cursor control key to direct the cursor to highlight a function of phonebook. Then, she may depress the select key and go to the phonebook interface on the screen 20. The interface may provide an option of adding new contact information, and the user may activate this function with the SELECT key. The interface displayed on the screen 20 may request for entry of alphanumerical data, such as the name, telephone number, address and e-mail address for the new contact information.

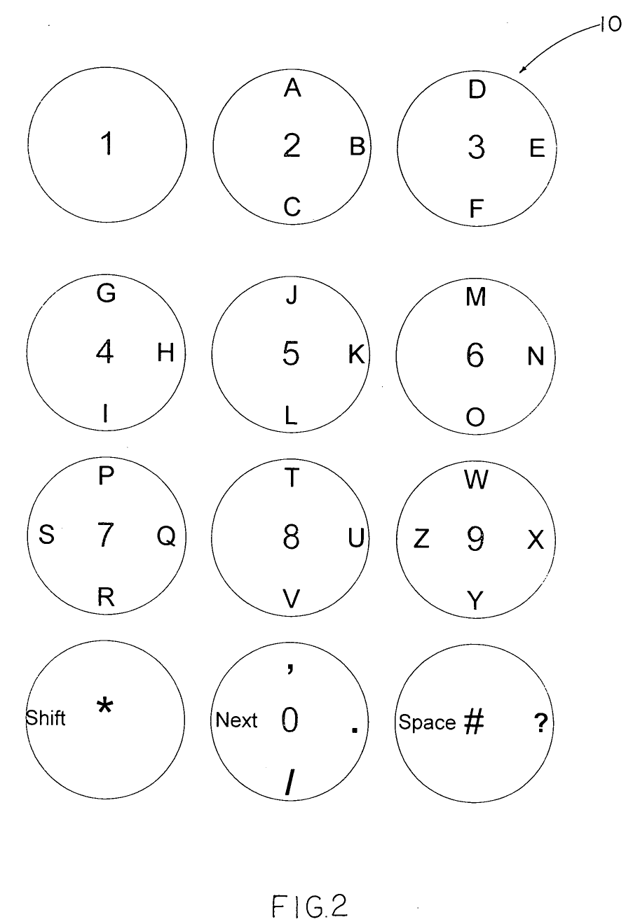

Referring to FIG. 2, an enlarged view of the first group of keys 10 for the keypad 10 is illustrated according the preferred embodiment of the present invention. The first group of keys 10 includes at least ten keys for the basic digits of decimal numerals, preferably twelve keys for the extra star key and pump key. Ten of the keys represent “0,” “2,” “3,” “4,” “5,” “6,” “7,” “8,” “9,” and “0,” according to an order from left to right and up to down. The star symbol “*” and pump symbol “#” are represented by the key aside the “0” key. Those numerals and star symbol and pump symbol are imprinted in the middle of the keys. Except the “1” key, each key further has one or more characters or special symbols imprinted thereon, and arranged around the its center area, which is imprinted of one the numerals, star symbol and pump symbol. In this preferred embodiment, the characters and special symbols of each key are generally arrangement in a 90-degree interval. For example, the “2” key has the numeral “2” imprinted in the center and characters “A,” “B,” and “C” arranged around the centered “2” in a 90-degree interval. For few keys, the characters and special symbols may be arranged in a 180-degree interval. For example, the pump key has the symbol “#” imprinted in the center and the special symbol “SPACE” and “?” imprinted around the center in a 180-degree interval. In this preferred embodiment, the characters are assigned to the numeral keys in the same manner as a traditional telephone keypad, like the “2” key is assigned with characters “A,” “B,” and “C,” just as the traditional one is assigned. It is noted that the characters may be assigned in a way different from the tradition without departing the spirit of the invention.

Each key has at least two orientations of freedom that permit the key to be selectively depressed along two directions, wherein one of the directions represents one of the basic digits of decimal numerals and the other of the directions represent various characters accordingly, such that the keypad is able to reduce a required number of the multidirectional keys in order for entering any digit of alphanumerical data with one action of depressing the multidirectional key to a certain direction.

It is preferable that each key has five orientations of freedom according to the embodiment. The center, top, bottom, left and right points can be depressed downwardly as five different directions that may selectively represent five commands, respectively. For example, the “2” key has characters “A,” “B,” and “C” arranged around it. When the center area of the key is depressed, it sends out a signal representing “2” to the phone. Likewise, when the top area is depressed, it sends out a signal representing “A” to the phone. Thus, only one action of depressing is required to enter “2,” “A,” “B,” or “C” with the multidirectional key. Thus, the number of depressing actions is reduced and unavoidable errors due to automatic word-choosing programs are eliminated.

It is noted that it is not required for every key to have five orientations of freedom. Two orientations are sufficient for some keys, three orientations are enough for some key, depending on how many types of command the key is designed to enter. It is also noted that more than five orientations may be possible, if the key is needed to enter more than five types of command.

The shape of the multidirectional keys may be made in a certain shape suitable for indicating various directions for entering various commands by a single key. In this preferred embodiment, the key is made of round shape, such that the user may look for the inputting the characters at the circumference of the key. It is noted that the key can be made in other shapes that are suitable for indication. For example, the key can be made in a shape of cross, wherein the numeral is imprinted on the center and the characters are selectively imprinted on the four ends of the cross. As an alternative, the key can be made in a shape of square, wherein the numeral is imprinted on the center and the characters are selectively imprinted on the four corners of the square.

The numerals, characters and symbols are raisedly imprinted on the keys for guiding a user to depress the key to a predetermined direction for a certain numeral, character or symbol with her touching of the key. Because they are protrudedly imprinted, the use may recognize their identities by touch the surface of the key. Thus, it eases the use of the keypad 10, even when it is operated without illumination.

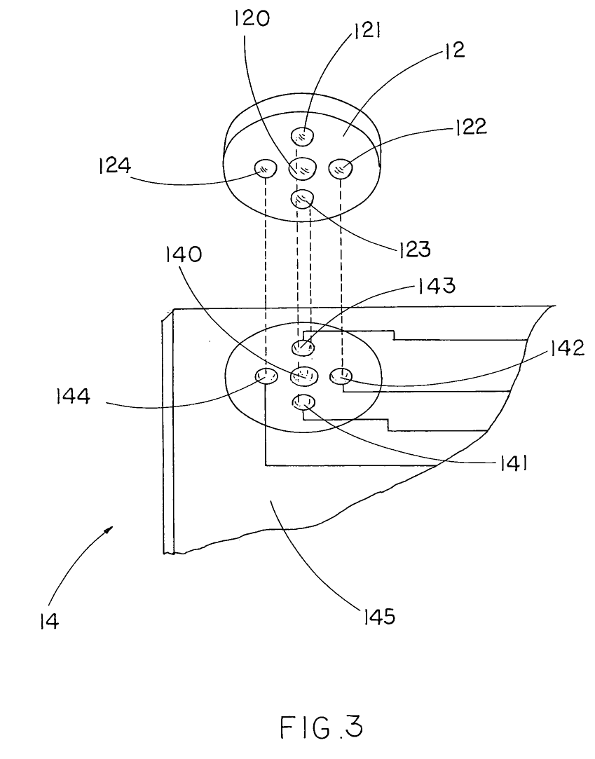

Referring to FIG. 3, a multidirectional key 12 and its corresponding conducting pads 141, 142, 143 and 144 are illustrated according to the preferred embodiment of the present invention. Here, the key 12 is illustrated as departing from the printed circuit board 145 for convenience of explanation, it is in fact moveably embedded on the printed circuit board 145 with its center, top, bottom, left and right portions depressable toward to the board 145.

The key 12 has five protruded nubs 120, 121, 122, 123 and 124, wherein the nub 120 at the center is outprotruded the rest nubs 121, 122, 123 and 124, formed on its bottom surface, which is corresponding to the conducting pads 140, 141, 142, 143 and 144, respectively. The conducting pads are electrically connected to a central processing unit (not shown in the figure) for reading the signals sent therefrom and displaying the numerals or characters represented by the signals on the screen 20 as shown in FIG. 1. When the key 12 is depressed to a direction, one of the nubs 120, 121, 122, 123 and 124 touches its corresponding conducting pad 140, 141, 142, 143 and 144 and activates a signal representing its predetermined numeral or character.

Sometimes, when the key is depressed to a direction two nubs would touch their corresponding conducting pads at the same time. For example, the user is intended to depress the right point of the key 12. However, she presses too hard that the nubs 122 and 120 touch the conducting pads 142 and 140 at the same time. In this preferred embodiment, if the nubs 122 and 120 touch the conducting pad 142 and 140 at the same time, it will be recognized as if only the nub 122 touches conducting pad 142. This is the same for nubs 121, 123 and 124, such that to which direction the key 12 is depresses can be more accurately read, for a hard press on the circumference of key 12 always causes the center nub 120 and one of the circumferential nubs 121, 122, 123 and 124 touches the conducting pad.

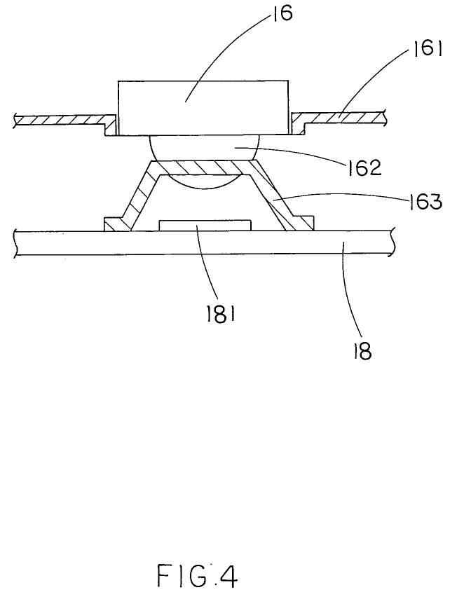

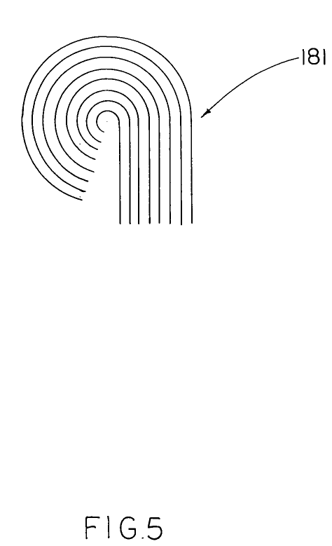

Referring to FIGS. 4 and 5 a multidirectional key 16 and its corresponding electrical components are illustrated, according to an alternative of the multidirectional key of the preferred embodiment of the present invention. A multidirectional key 16 is moveably mounted on a supporting frame 161. A pressure protrusion 162 is attached to the bottom surface of the multidirectional key 16, and mounted on an elastic member 163, which is mounted on the printed circuit board 18. A set of conductor tracks 181 are formed on the printed circuit board 18, wherein the tracks 181 are made of materials whose resistance is adjustable in response to pressure applied thereon. After the depressing force is withdrawn, the elastic member 163 will bounce back to its original shape and resume the key 16 to its regular position.

When the key 16 is depressed downwardly, the pressure protrusion 162 deforms the elastic member 163 and pressurizes the conductor tracks 181 in a certain area according to the directions of depressing. Because various types of pressurization vary the resistance distribution of the conductor tracks 181, the electrical current flowing through the conductor tracks 181 varies accordingly. The two ends of the conductors are electrically connected to the central processing unit, which analyzes various patterns of the output current of the conductors tracks 181 in order to determination from which direction the tracks 181 are pressurized. As such, the central processing unit is able to understand the movement of the key 16 along different directions. As discussed above, a direction represents a numeral, character or symbol, so that the key 18 is able to enter various alphanumericals.

The present invention further comprises a method of entering a digit of alphanumerical data with one action of depressing via a keypad for phones, wherein the method comprises the following steps:
(1) providing at least ten multidirectional keys respectively representing basic digits of decimal numerals, wherein each multidirectional key has at least two orientations of freedom permitting the multidirectional key to be selectively depressed along at least two different directions, wherein one of the directions represents one of the basic digits of decimal numerals and the other of the directions represent various characters accordingly.
(2) depressing the multidirectional key to a certain direction to electrically manipulate a circuitry in such a way that the circuit effects a signal representing a certain numeral, character or symbol, whereby the multidirectional key is capable of inputting at least two commands, such that the keypad is able to reduce a required number of the multidirectional keys in order for entering any digit of alphanumerical data with one action of depressing the multidirectional key to a certain direction.

In step (1), the number of the multidirectional keys may expand to twelve as a traditional keypad may have. The two extra keys are the star key and pump key, which have their special functions for certain use.

In step (1), the number of orientation of freedom may expand to five in order to include all the twenty six English letters on the keypad. As such, each numeral or letter will be represented by an orientation of freedom, and the entry of any digit of the alphanumerical data may be completed with one action of depressing.

The present invention has the advantage of simplicity and time-saving. No repetitive actions of depressing are required to enter a digit of alphanumerical data, such that it is simple way for data entry and time-saving for users to use the disclosed keypad. No extra keys are required, so that the keypad remains small and the phone that adopts the keypad remains compact. Furthermore, the present invention has another advantage of eliminating the risk of entering the wrong data.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A keypad for entering alphanumerical data, comprising:
at least ten multidirectional keys respectively representing basic digits of decimal numerals, wherein each multidirectional key has at least two orientations of freedom permitting said multidirectional key to be selectively depressed along at least two different directions, one of said directions represents one of said basic digits of decimal numerals and other directions represent various characters, such that said keypad is capable of reducing number of said multidirectional keys in order to enter any digit of alphanumerical data with one action of depressing said multidirectional key to a predetermined direction.

2. The keypad for entering alphanumerical data, as recited in claim 1, wherein each of said multidirectional keys is shaped and sized to indicate a plurality of directions so as to ensure said multidirectional key being depressed to enter various command through a single key.

3. The keypad for entering alphanumerical data, as recited in claim 1, wherein each of said multidirectional key has five operational portions, namely, a center portion, a top portion, a bottom portion, a left portion, and a right portion.

4. The keypad for entering alphanumerical data, as recited in claim 2, wherein each of said multidirectional key has five operational portions, namely, a center portion, a top portion, a bottom portion, a left portion, and a right portion.

5. The keypad for entering alphanumerical data, as recited in claim 3, wherein said multidirectional key is moveably embedded on a printed circuit board with said center portion, said top portion, said bottom portion, said left portion and said right portion being depressable towards said printed circuit board, each of said multidirectional key comprises five protruded nubs extended from a bottom surface thereon for correspondingly mating with a plurality of conducting pads defined on said printed circuit board, wherein said conducting pads are electrically connected to a central processing unit, which is adapted for reading signals sent from said conducting pads and displaying said numerals and said characters on a screen, so that by depressing different portion of said multidirectional key, said screen is capable of showing different alphanumerical data.

6. The keypad for entering alphanumerical data, as recited in claim 4, wherein said multidirectional key is moveably embedded on a printed circuit board with said center portion, said top portion, said bottom portion, said left portion and said right portion being depressable towards said printed circuit board, each of said multidirectional key comprises five protruded nubs extended from a bottom surface thereon for correspondingly mating with a plurality of conducting pads defined on said printed circuit board, wherein said conducting pads are electrically connected to a central processing unit, which is adapted for reading signals sent from said conducting pads and displaying said numerals and said characters on a screen, so that by depressing different portion of said multidirectional key, said screen is capable of showing different alphanumerical data.

7. The keypad for entering alphanumerical data, as recited in claim 5, wherein said multidirectional key is round shape, wherein said top portion, said bottom portion, said left portion and said right portion are defined along a circumference of said multidirectional key accordingly, so that a user is able to input said characters by depressing said circumference of said multidirectional key.

8. The keypad for entering alphanumerical data, as recited in claim 6, wherein said multidirectional key is round shape, wherein said top portion, said bottom portion, said left portion and said right portion are defined along a circumference of said multidirectional key accordingly, so that a user is able to input said characters by depressing said circumference of said multidirectional key.

9. The keypad for entering alphanumerical data, as recited in claim 5, wherein said multidirectional key is cross shaped, said center portion is define on a center of said cross for imprinted said numeral, and said top portion, said bottom portion, said left portion and said right portion said characters are respectively provided at four ends of said cross to selectively imprint said characters.

10. The keypad for entering alphanumerical data, as recited in claim 6, wherein said multidirectional key is cross shaped, said center portion is define on a center of said cross for imprinted said numeral, and said top portion, said bottom portion, said left portion and said right portion said characters are respectively provided at four ends of said cross to selectively imprint said characters.

11. The keypad for entering alphanumerical data, as recited in claim 5, wherein said multidirectional key is square shaped, said center portion is define on a center of said square for imprinted said numeral, and said top portion, said bottom portion, said left portion and said right portion said characters are respectively provided at four corners of said square to selectively imprint said characters.

12. The keypad for entering alphanumerical data, as recited in claim 6, wherein said multidirectional key is square shaped, said center portion is define on a center of said square for imprinted said numeral, and said top portion, said bottom portion, said left portion and said right portion said characters are respectively provided at four corners of said square to selectively imprint said characters.

13. The keypad for entering alphanumerical data, as recited in claim 1, wherein said numerals and said characters are raisedly imprinted on said multidirectional keys for guiding a user to depress said multidirectional key to a predetermined direction to selective input said numerals and said characters.

14. The keypad for entering alphanumerical data, as recited in claim 5, wherein said numerals and said characters are raisedly imprinted on said multidirectional keys for guiding a user to depress said multidirectional key to a predetermined direction to selective input said numerals and said characters.

15. The keypad for entering alphanumerical data, as recited in claim 7, wherein said numerals and said characters are raisedly imprinted on said multidirectional keys for guiding a user to depress said multidirectional key to a predetermined direction to selective input said numerals and said characters.

16. The keypad for entering alphanumerical data, as recited in claim 9, wherein said numerals and said characters are raisedly imprinted on said multidirectional keys for guiding a user to depress said multidirectional key to a predetermined direction to selective input said numerals and said characters.

17. A method for entering a digit of alphanumerical data with one action of depressing via a keypad for phones, wherein said method comprises following steps:
(a) providing at least ten multidirectional keys respectively representing basic digits of decimal numerals, wherein each multidirectional key has at least two orientations of freedom permitting said multidirectional key to be selectively depressed along at least two different directions, wherein one of said direction represents one of said basic digits of decimal numerals and the other of said directions represent various characters accordingly.
(b) depressing said multidirectional key to a certain direction to electrically manipulate a circuitry in such a way that said circuit effects a signal representing an alphanumerical symbol, so that said multidirectional key is capable of inputting at least two commands, said keypad is capable of reducing a required number of said multidirectional keys in order to enter any digit of alphanumerical data with one action of depressing said multidirectional key to a certain direction.

18. The method, as recited in claim 17, wherein each of said multidirectional keys is shaped and sized to indicate a plurality of directions so as to ensure said multidirectional key being depressed to enter various command through a single key.

19. The method, as recited in claim 18, wherein each of said multidirectional key has five operational portions, namely, a center portion, a top portion, a bottom portion, a left portion, and a right portion.

20. The method, as recited in claim 19, wherein said multidirectional key is moveably embedded on a printed circuit board with said center portion, said top portion, said bottom portion, said left portion and said right portion being depressable towards said printed circuit board, each of said multidirectional key comprises five protruded nubs extended from a bottom surface thereon for correspondingly mating with a plurality of conducting pads defined on said printed circuit board, wherein said conducting pads are electrically connected to a central processing unit, which is adapted for reading signals sent from said conducting pads and displaying said numerals and said characters on a screen, so that by depressing different portion of said multidirectional key, said screen is capable of showing different alphanumerical data.
